(19) United States
(12) Patent Application Publication
(10) Pub. No.: US 2025/0166062 A1
(43) Pub. Date: May 22, 2025

(54) ASSESSMENT ENGINES AND METHODS OF OPERATING THEREOF

(71) Applicant: Michael SHVARTSMAN, Hollywood, FL (US)

(72) Inventor: Michael SHVARTSMAN, Hollywood, FL (US)

(21) Appl. No.: 18/835,171

(22) PCT Filed: Feb. 7, 2022
(86) PCT No.: PCT/IB2022/051084

§ 371 Date: Aug. 1, 2024

(51) Int. Cl. G06Q 40/03; G06N 3/02

(52) U.S. Cl. CPC G06Q 40/03; G06N 3/02

(57) ABSTRACT

There is provided a method including obtaining at an assessment engine a list of transactions selected from a transaction history associated with a payment account, and outputting at an output terminal the list of transactions. The method also includes receiving at the assessment engine a loan request comprising a selection of a transaction of a given amount from the list of transactions, and obtaining at the assessment engine an assessment of the loan request based on parameters comprising the given amount. Moreover, the method includes generating at the assessment engine an approval indicator associated with the loan request of the given amount based on the assessment, obtaining at the assessment engine repayment terms associated with the loan request based on the assessment, and outputting one or more of the approval indicator and the repayment terms.

### FIELD

The present specification relates to assessment engines and methods of operating hereof, and in particular to assessment engines for assessing a request and methods of operating hereof.

### BACKGROUND

Various entities such as machines, individuals, and institutions may interact. These interactions may take the form of requests exchanged between these entities. These requests may be assessed to determine actions and events as part of the interactions.

### SUMMARY

According to an implementation of the present specification there is provided a method comprising: obtaining at an assessment engine a list of transactions selected from a transaction history associated with a payment account; outputting at an output terminal the list of transactions; receiving at the assessment engine a loan request comprising a selection of a transaction of a given amount from the list of transactions; obtaining at the assessment engine an assessment of the loan request based on parameters comprising the given amount; generating at the assessment engine an approval indicator associated with the loan request of the given amount based on the assessment; obtaining at the assessment engine repayment terms associated with the loan request based on the assessment; and outputting one or more of the approval indicator and the repayment terms.

The assessment engine may comprise an Artificial Intelligence (AI)-enabled module to be used to perform one of more of the obtaining the assessment, the generating the approval indictor, and the obtaining the repayment terms.

The AI-enabled module may comprise a trained machine learning model.

The trained machine learning model may comprise a trained neural network.

The obtaining the assessment may comprise generating the assessment at the assessment engine based on the parameters.

The parameters may further comprise one or more of: a selection of transactions associated with the payment account, a credit report, and a credit score.

The obtaining the assessment may comprise generating at the assessment engine the assessment comprising a creditworthiness indicator; and one or more of: the generating the approval indicator may comprise generating the approval indicator based on the creditworthiness indicator; and the obtaining the repayment terms may comprise generating the repayment terms at the assessment engine based on the creditworthiness indicator.

The method may further comprise: transferring loan funds of the given amount to a destination account associated with a requester associated with the payment account.

The destination account may be the payment account.

The method may further comprise: collecting funds from a source account based on the repayment terms, the source account associated with a requester associated with the payment account.

The source account may be the payment account.

The method may further comprise: sending from the assessment engine to a bid gateway the loan request; receiving at the assessment engine from the bid gateway one or more bids to lend the given amount; and generating the approval indicator based on the one or more bids.

The obtaining the assessment may comprise generating the assessment at the assessment engine based on the parameters; and the method may further comprise: sending from the assessment engine to the bid gateway the assessment.

The obtaining the repayment terms may comprise generating the repayment terms at the assessment engine based on the assessment; and the method may further comprise: sending from the assessment engine to the bid gateway the repayment terms.

The method may further comprise: sending the parameters from the assessment engine to the bid gateway; and wherein: the one or more bids each comprise a bidder-generated assessment; and the obtaining the assessment at the assessment engine may comprise receiving at the assessment engine the bidder-generated assessment.

The method may further comprise: sending one or more of the parameters and the assessment from the assessment engine to the bid gateway; and wherein: the one or more bids each comprise bidder-generated repayment terms; and the obtaining the repayment terms at the assessment engine may comprise receiving at the assessment engine the bidder-generated repayment terms.

The method may further comprise: selecting at the assessment engine a successful bid from among the one or more bids; and wherein, one or more of: the generating the approval indicator may comprise generating at the assessment engine the approval indicator based on the successful bid; and the obtaining the repayment terms may comprise obtaining at the assessment engine repayment terms associated with the successful bid.

The method may further comprise: receiving at the assessment engine account credentials for accessing the payment account.

The payment account may comprise one of a credit card, debit card, electronic payment account, and cryptocurrency account.

According to another implementation of the present specification there is provided an assessment engine comprising: a memory to store a list of transactions selected from a transaction history associated with a payment account; and a processor in communication with the memory, the processor to: obtain the list of transactions; control an output terminal to output the list of transactions; receive a loan request comprising a selection of a transaction of a given amount from the list of transactions; obtain an assessment of the loan request based on parameters comprising the given amount; generate an approval indicator associated with the loan request of the given amount based on the assessment; obtain repayment terms associated with the loan request based on the assessment; and output one or more of the approval indicator and the repayment terms.

The assessment engine may comprise an Artificial Intelligence (AI)-enabled module; and the processor may be to use the AI-enabled module to one of more of obtain the assessment, generate the approval indictor, and obtain the repayment terms.

The AI-enabled module may comprise a trained machine learning model.

The trained machine learning model may comprise a trained neural network.

To obtain the assessment the processor may be to generate the assessment based on the parameters.

The parameters may further comprise one or more of: a selection of transactions associated with the payment account, a credit report, and a credit score.

To obtain the assessment the processor may be to generate the assessment comprising a creditworthiness indicator; and one or more of: to generate the approval indicator the processor may be to generate the approval indicator based on the creditworthiness indicator; and to obtain the repayment terms the processor may be to generate the repayment terms based on the creditworthiness indicator.

The processor may be further to: transfer loan funds of the given amount to a destination account associated with a requester associated with the payment account.

The destination account may be the payment account.

The processor may be further to: collect funds from a source account based on the repayment terms, the source account associated with a requester associated with the payment account.

The source account may be the payment account.

The processor may be further to: send to a bid gateway the loan request; receive from the bid gateway one or more bids to lend the given amount; and generate the approval indicator based on the one or more bids.

To obtain the assessment the processor may be to generate the assessment based on the parameters; and send to the bid gateway the assessment.

To obtain the repayment terms the processor may be to generate the repayment terms based on the assessment; and the processor may be further to: send to the bid gateway the repayment terms.

The processor may be further to: send the parameters to the bid gateway; and wherein: the one or more bids each comprise a bidder-generated assessment; and to obtain the assessment the processor may be to receive the bidder-generated assessment.

The processor may be further to: send one or more of the parameters and the assessment to the bid gateway; and wherein: the one or more bids each comprise bidder-generated repayment terms; and to obtain the repayment terms the processor may be to receive the bidder-generated repayment terms.

The processor may be further to: select a successful bid from among the one or more bids; and wherein, one or more of: to generate the approval indicator the processor may be to generate the approval indicator based on the successful bid; and to obtain the repayment terms the processor may be to obtain repayment terms associated with the successful bid.

The processor may be further to: receive account credentials for accessing the payment account.

The payment account may comprise one of a credit card, debit card, electronic payment account, and cryptocurrency account.

According to another implementation of the present specification there is provided a non-transitory computer-readable storage medium comprising instructions executable by a processor, the instructions to cause the processor to carry out any of the methods described herein.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 shows a flowchart of an example method for operating an assessment engine, in accordance with a non-limiting implementation of the present specification.

FIG. 2 shows an example system, in accordance with a non-limiting implementation of the present specification.

FIG. 3 shows a block diagram of an example assessment engine, in accordance with a non-limiting implementation of the present specification.

FIG. 4 shows a block diagram of an example computer-readable storage medium, in accordance with a non-limiting implementation of the present specification.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, and the like. In other instances, well-known structures associated with light sources have not been shown or described in detail to avoid unnecessarily obscuring descriptions of the implementations.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

Machine-based assessment engines may be used to assess some requests exchanged in the course of interactions between individuals, institutions, or machines. In some examples, these requests may be digital or electronic requests. Moreover, in some examples, such machine-based assessment engines may be computer-implemented. Such assessment engines may allow the requests to be processed faster, more accurately, more securely, and in a manner that is more respectful of privacy considerations. In addition, such assessment engines may allow the requests to be processed in a more consistent and objective manner. Moreover, such assessment engines may use machine learning to learn, adapt, and improve their assessment functionality.

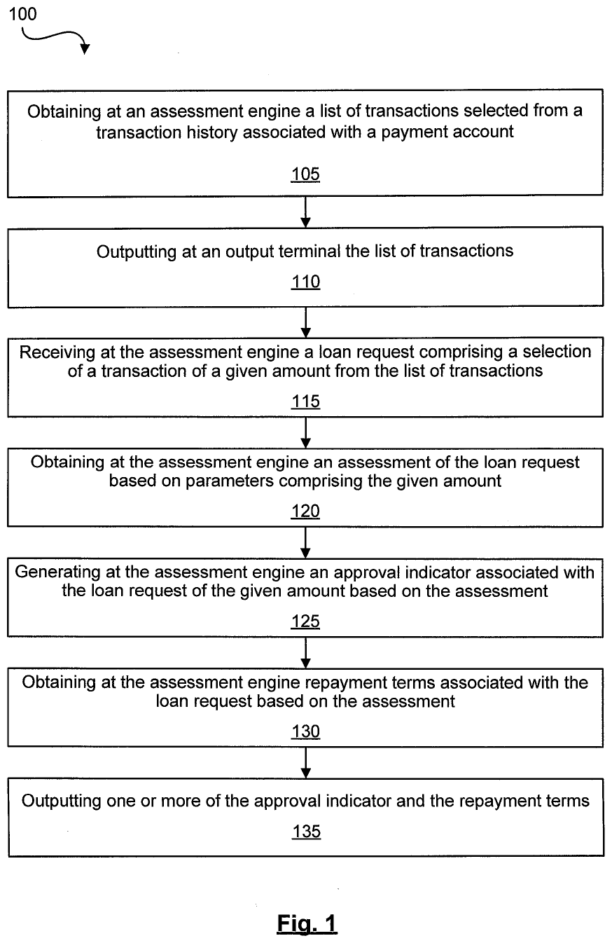

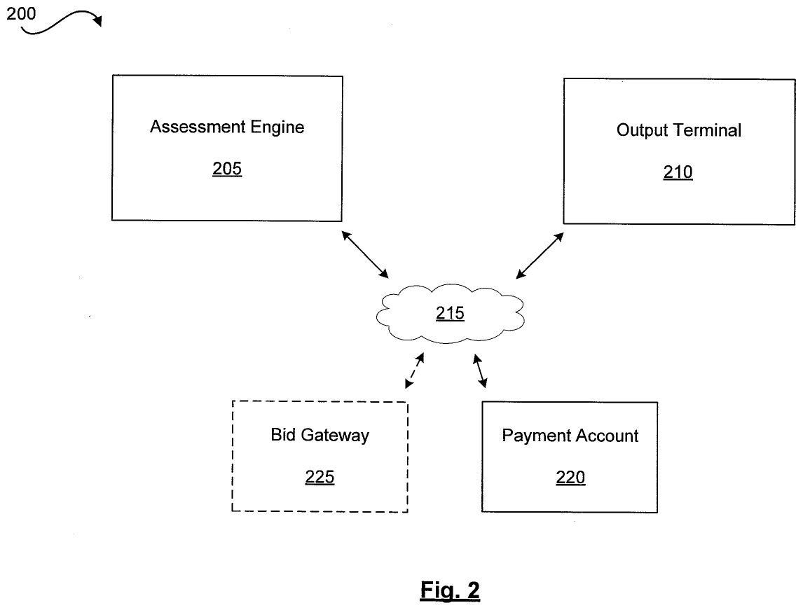

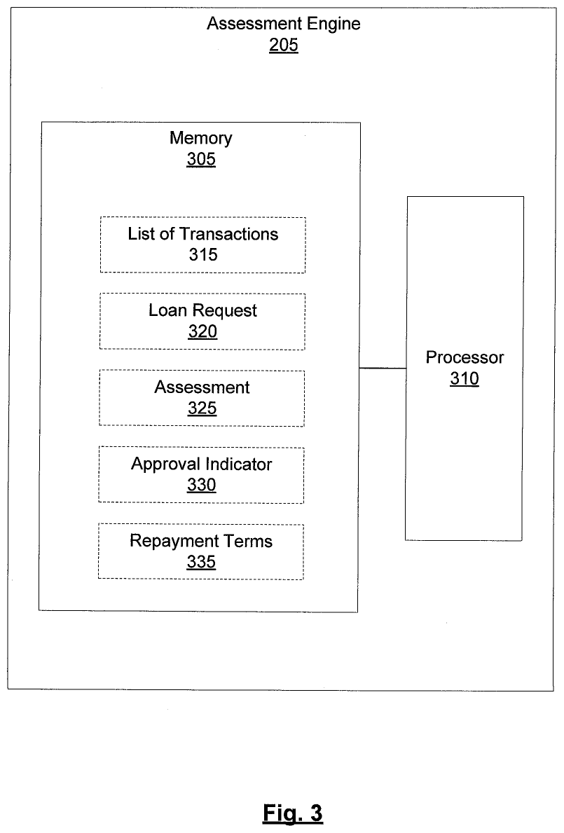

In some examples, a purchaser may have made a purchase or submitted a payment. That purchaser may then wish to reverse or rewind that purchase. Undoing such a purchase or payment may not always be possible. An assessment engine may receive the purchaser's request to rewind the purchaser's payment. The assessment engine may then assess this request, and a loan matching the purchaser's payment amount may be provided to the purchaser to effectively rewind the purchase. FIG. 1 shows an example method 100 for operating an assessment engine. FIGS. 2 and 3 show an example assessment engine 205, which may be used to perform method 100 and the other methods described herein. Method 100 may be used to assess the loan request associated with a transaction. Such a loan could then be used to effectively rewind the transaction, such as a purchase or payment.

Turing now to FIG. 1, at box 105 a list of transactions selected from a transaction history associated with a payment account may be obtained at an assessment engine. The list of transactions may comprise or take the form of digital data, a digital data structure, a digital data packet, and the like. In some examples, such digital data may be communicated as an electrical analogue or digital signal, an in-wire or wireless signal, or the like. An example payment account 220 is depicted schematically in FIG. 2. In some examples, the payment account may comprise, or be associated with, a credit card, a debit card, another payment card, a bank account, a payment account including an electronic payment account, a cryptocurrency account, and the like. The transaction history may comprise a list of debits and credits associated with the payment account. This list may include, for each transaction, one or more of the amount, date, debit or credit designation, the description of the transaction, and the like. Furthermore, in some examples, the list of transactions may be selected from the transaction history. Such a selection may be based on different parameters such as a date or date range, the amount or amount range, description of the transaction, and the like.

In some examples, the assessment engine may receive the list of transactions directly from a repository associated with the payment account. Moreover, in some examples, the assessment engine may request the list of transactions from such a repository. Furthermore, in some examples, the assessment engine may receive the list of transactions from an intermediary or third-party repository containing the list of transactions. For example, in order to sign up a purchaser for the purchase rewind functionalities described herein, the assessment engine may receive payment account credentials associated with the purchaser. The assessment engine may then use these credentials to directly or indirectly connect with the payment account and obtain a list of transactions from the transaction history associated with the payment account.

At box 110, the list of transactions may be output at an output terminal. An example output terminal 210 is depicted schematically in FIG. 2. In some examples, the output terminal may comprise a visual output terminal, an audio output terminal, a touch or haptic output terminal, and the like. An example of the visual output terminal may include a screen. Moreover, an example of the audio output terminal may include speakers. Examples of the touch or haptic output terminal may include a haptic engine, a Braille output terminal, and the like. In some examples, the output terminal may be part of a mobile device, a wearable device, a computer or computing terminal, and the like.

In addition, in some examples, the list of transactions may be output by the assessment engine. In such examples, the assessment engine may directly or indirectly control the output terminal to output the list of transactions. In some examples, outputting the list may comprise outputting some or all of the information contained in the list. Furthermore, in some examples, information contained in the list may be selected, edited, reformatted, or otherwise altered in the process of being output. In addition, it is contemplated that in some examples, the output terminal may be part of, or a component of, the assessment engine.

Outputting the list of transactions may allow the purchaser to select a transaction that they wish to “rewind”. In some examples, such a rewinding may be effectively implemented when assessing a loan for the purchaser of the same amount as the transaction to be rewound. It is also contemplated that in some examples more than one transaction may be selected for rewinding.

At box 115, a loan request comprising a selection of a transaction of a given amount from the list of transactions may be received at the assessment engine. The selection may comprise or take the form of digital data, a digital data structure, a digital data packet, and the like. The selection may have been made by a purchaser or user. It is also contemplated that in some examples, the selection may have been made by a machine. For example, a digital or artificial intelligence (AI) engine or AI assistant may have made the selection on behalf of the purchaser or user.

At box 120, an assessment of the loan request may be obtained at the assessment engine. The assessment may comprise or take the form of digital data, a digital data structure, a digital data packet, or the like. This assessment may be based on parameters comprising the given amount of the loan request. In some examples, the assessment engine may generate the assessment. In some examples, this assessment by the assessment engine may include the assessment engine assessing the loan request to determine whether the loan should be approved. It is also contemplated that in some examples, the assessment engine may receive this assessment from a system or entity outside the assessment engine.

This assessment may be based on parameters that may include the amount of the loan. The amount of the loan may correspond to the amount of the transaction that is being sought to be rewound. In some examples, other parameters may also be considered as part of the assessment. Examples of such other parameters may include a credit report or credit score associated with the purchaser or user. Moreover, in some examples, a list or history of other transactions associated with the payment account may also be considered. Such a history may be informative as to the likely upcoming debits and credits to the payment account, which may in turn impact the ability of the purchaser to repay the requested loan. In addition, transaction history may also reveal past delinquent payments, which may also be relevant to the likelihood of the purchaser repaying the requested loan.

Furthermore, in some examples, in order to obtain the assessment of the loan request the assessment engine may generate a creditworthiness indicator. Such a creditworthiness indicator may be generated based on the parameters described above in relation to the loan request. Moreover, in some examples, such a creditworthiness indicator may be generated on the basis of underwriting performed in relation to the loan request. In some examples, this underwriting may be performed by the assessment engine. In addition, in some examples, the underwriting may be performed by an underwriting module. In some examples, this underwriting module may be AI-enabled. For example, the underwriting module may comprise a trained machine learning model for assessing the loan request and generating a creditworthiness indicator. In some examples, the machine learning model may comprise a neural network. It is also contemplated that in some examples, the underwriting may be performed by an entity outside the assessment engine.

Turning now to box 125, an approval indicator may be generated at the assessment engine. The approval indicator may comprise or take the form of digital data, a digital data structure, a digital data packet, and the like. This approval indicator may be associated with the loan request of the given amount based on the assessment. In some examples, this approval indicator may comprise a binary affirmative-or-negative indicator. Moreover, in some examples, an affirmative approval indicator may correspond to an approval of the loan request. It is also contemplated that in some examples, the approval indicator may have a range of values to indicate the strength of the recommendation to either approve or reject the loan request.

At box 130, repayment terms may be obtained at the assessment engine. The repayment terms may comprise or take the form of digital data, a digital data structure, a digital data packet, and the like. These repayment terms may be associated with the loan request. Furthermore, in some examples, repayment terms may include an interest rate, the repayment term or duration, the amount or frequency of repayment installments, and the like. In some examples, the repayment terms may be based on the assessment of the loan request. For example, if the loan request is assessed to be relatively riskier, the interest rate on the loan may be higher or the other repayment rates may be relatively less favorable to the borrower. If, on the other hand, the loan request is assessed to be relatively less risky, the interest rate may be lower or the other repayment terms may be relatively more favorable to the borrower.

In some examples where obtaining the assessment comprises generating the creditworthiness indicator, the approval indicator may be based on the creditworthiness indicator. For example, the approval indicator may be affirmative and the loan request may be approved if the creditworthiness indicator is above a certain threshold. Moreover, in some examples where obtaining the assessment comprises generating the creditworthiness indicator, the repayment terms may be generated based on the creditworthiness indicator. As discussed above, a more creditworthy borrower may be able to receive more favorable repayment terms, whereas a relatively less creditworthy borrower may receive relatively less favorable repayment terms.

Turning now to box 135, one or more of the approval indicator and the repayment terms may be output. In some examples, the assessment engine may directly or indirectly output the approval indicator or the repayment terms. In addition, in some examples, outputting the approval indicator or the repayment terms may comprise storing the approval indicator or the repayment terms in a computer-readable memory, sending the approval indicator or the repayment terms to an output terminal, communicating the approval indicator or the repayment terms to another component or to another system, or the like. This output terminal may be the same as, or different than, the output terminal at which the list of transactions was output in box 110. Moreover, in some examples, outputting the approval indicator or the repayment terms may comprise printing the approval indicator or the repayment terms. Furthermore, in some examples, outputting the approval indicator or the repayment terms may comprise sending the approval indicator or the repayment terms to a computing device of the purchaser/borrower.

In some examples, method 100 may further comprise transferring loan funds of the given amount to a destination account associated with the request or associated with the payment account. In other words, loan funds may be sent or transferred to the destination account of the requester. In some examples, the assessment engine may directly or indirectly authorize or perform the transferring of the loan funds. Furthermore, in some examples, the destination account may be the same type of account as the payment account. Moreover, in some examples, the destination account may be the same account as the payment account.

In addition, in some examples, method 100 may further comprise collecting funds from a source account based on the repayment terms. The source account may be associated with the requester associated with the payment account. In other words, funds may be collected from the source account of the requester to repay the loan. In some examples, the assessment engine may directly or indirectly authorize or perform the collecting of funds from the source account. Moreover, in some examples, the source account may be the same type of account as the payment account. Furthermore, in some examples, the source account may be the same account as the payment account.

In some examples, the option to provide the requested loan to the user or purchaser may be offered to other entities or third parties. These third parties may then bid to secure the option of providing the requested loan. These third parties may comprise organizations, institutions, or individuals, or bidding or decision-making engines or modules operated by or on behalf of organizations, institutions, or individuals. In order to facilitate the soliciting or receiving of bids for loan requests, in some examples the loan request may be sent from the assessment engine to a bid gateway. An example bid gateway 225 is shown schematically in FIG. 2. In some examples, the bid gateway may comprise a computing module such as a server, a collection of servers, one or more distributed or virtualized computing modules, a cloud-based module, and the like.

The assessment engine may then receive from the bid gateway one or more bids to lend the given amount. These bids may each comprise or take the form of digital data, a digital data structure, a digital data packet, or the like. Once the assessment engine receives the one or more bids, the assessment engine may generate the approval indicator based on the bids. For example, the assessment engine may generate the approval indicator if a bid is received to provide the requested loan. If no bid is received, no approval indicator may be generated. In other words, in such examples the assessment engine may approve the loan request only if a bid is received from a third party to provide the loan. Moreover, in some examples, there may be minimum thresholds that a bid would need to meet before that bid is deemed acceptable by the assessment engine. Examples of such thresholds may include a minimum commission amount to be provided by the third party bidder, repayment terms for the loan, and the like.

In some examples, the assessment of the loan request based on the parameters may be performed by the assessment engine. This assessment may then be sent by the assessment engine to the bid gateway to provide further information to the potential third party bidders. Similarly, in some examples, the assessment engine may generate the repayment terms for the loan based on the assessment. The assessment engine may then send these repayment terms to the bid gateway to provide further information to the potential third party bidders.

Furthermore, in some examples, the bidders may generate their own assessment or repayment terms for the loan request. In some such examples, the parameters associated with the loan request may be sent from the assessment engine to the bid gateway. In this manner, the parameters may be made available to potential bidders to facilitate their generating their own assessment or repayment terms. In some such examples, one or more of the bids may each comprise a bidder-generated assessment. Obtaining the assessment at the assessment engine may then comprise receiving at the assessment engine the bidder-generated assessments.

Similarly, in some examples, one or more of the parameters and the assessment may be sent from the assessment engine to the bid gateway to inform the potential bidders. The bidders may then use this information to generate bids that comprise bidder-generate repayment terms. In some such examples, obtaining the repayment terms at the assessment engine may comprise receiving at the assessment engine the bidder-generated repayment terms.

If more than one acceptable bid is received via the bid gateway, the assessment engine may select a successful bid from among the bids. The assessment engine may select the successful bid based on criteria such as the highest commission, the most favorable repayment terms, and the like. In some such examples, generating the approval indicator at the assessment engine may comprise generating at the assessment engine the approval indicator based on the successful bid. For example, if a bid is selected as being successful, then the assessment engine may generate the approval indicator to indicate that the loan request has been approved.

In addition, in some such examples, obtaining the repayment terms may comprise obtaining at the assessment engine the repayment terms associated with the successful bid. As discussed above, these repayment terms may have been generated by the assessment engine or by a bidder. In other words, selection of a successful bid may also include obtaining or selecting the repayment terms that are associated with that successful bid.

Turning now to FIG. 2, a schematic representation is shown of example system 200, which may be used to implement method 100 and the other methods described herein. System 200 comprises assessment engine 205 and output terminal 210 in communication with one another via a network 215. In some examples, network 215 may comprise a wired, wireless, or combined wired and wireless communication network. Network 215 may comprise a cellular network, a satellite network, the Internet, a local area network, a wide area network, a WiFi network, a wired or landline phone network, and the like. While FIG. 2 shows output terminal 210 as being separate from assessment engine 205, it is contemplated that in some examples the assessment engine and the output terminal need not be separate and one may be incorporated into or combined with the other.

System 200 also depicts payment account 220, which may also be in communication with one or more of the other components of system 200 via network 215. In some examples, the payment account itself need not be able to communicate, but the platform or system offering, implementing, or managing the payment account may be able to communicate information about the payment account to the other components of system 200.

Moreover, FIG. 2 also depicts example bid gateway 225. In FIG. 2 bid gateway 225 is shown in dashed lines to indicate that in some examples system 200 need not comprise a bid gateway. In some such examples, the organization or entity operating the assessment engine may also provide the requested loans, which would obviate the need to receive bids from third parties. Furthermore, while FIG. 2 shows the components of system 200 communicating via network 215, it is contemplated that in some examples, a component may communicate with one or more of the other components directly or via a communication network other than network 215.

As discussed above, in some examples, the assessment engine may comprise an Artificial Intelligence (AI)-enabled module. This module may be implanted in hardware, software, or a combination of hardware and software. Such a module may be used to perform one of more of the obtaining the assessment, the generating the approval indictor, the obtaining the repayment terms, and the like. In some examples, the AI-enabled module may comprise a trained machine learning model. Moreover, in some examples, the trained machine learning model may comprise a trained neural network.

The implementation of the AI-enabled module may be selected to best suite the machine learning model used. A cloud-based implementation may be used to provide access to large amounts of computing power. Specifically designed hardware processor chips may also be used to enhance the implementation of the machine learning model. In addition, in some examples, the machine learning model may continue to be trained in operation, to allow for performance improvements over time. For example, repayment or recovery rates for loan requests approved by an AI-enabled assessment engine may be used continue training the AI-enabled module to enhance the performance of the assessment engine.

Turning now to FIG. 3, a block diagram is shown of example assessment engine 205, which comprises a memory 305 in communication with a processor 310. In some examples, assessment engine 205 may have the features or functionality described in relation to method 100 and the other methods described herein. Furthermore, in some examples, assessment engine 205 may be used to perform method 100 and the other methods described herein.

In some examples, memory 305 may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, cloud-based storage, virtualized storage, and the like. The machine-readable storage medium may be encoded with executable instructions. Memory 305 may store a list of transactions 315 selected from a transaction history associated with a payment account.

Processor 310, in turn, may include a central processing unit (CPU), a graphics processing unit (GPU), a microcontroller, a microprocessor, a processing core, a field-programmable gate array (FPGA), a virtualized processor, or similar device or module capable of executing instructions. In some examples, processor 310 may comprise a processing module or capability that may be distributed, virtualized, cloud-based, or the like. Processor 310 may be in communication with, and cooperate with, memory 305 to execute instructions.

Processor 310 may obtain a list of transactions 315. Moreover, processor 310 may control an output terminal to output list of transactions 315. Processor 310 may control the output terminal directly or indirectly. In addition, it is contemplated that in some examples, in producing the output the form or substance of list of transactions 315 may be modified to produce an output that is based on or reflective of at least some of the information contained in list of transactions 315. The obtaining of the list of transactions and outputting the list may be similar to the corresponding functions described in relation to method 100 and the other methods described herein.

Moreover, processor 310 may receive a loan request 320 comprising a selection of a transaction of a given amount from the list of transactions. Processor 310 may also obtain an assessment 325 of loan request 320 based on parameters comprising the given amount. In some examples, processor 310 may generate assessment 325. Moreover, in some examples, assessment 325 may be generated by an entity other than processor 310, stored in memory 305, and then obtained or retrieved by processor 310. The receiving the loan request and obtaining the assessment may be similar to the corresponding functions described in relation to method 100 and the other methods described herein.

In addition, processor 310 may generate an approval indicator 330 associated with loan request 320 of the given amount based on assessment 325. Processor 310 may also obtain repayment terms 335 associated with loan request 320 based on assessment 325. In some examples, processor 310 may generate repayment terms 335. Moreover, in some examples, repayment terms 335 may be generated by an entity other than processor 310, stored in memory 305, and then obtained or retrieved by processor 310. The generating the approval indicator and obtaining the repayment terms may be similar to the corresponding functions described in relation to method 100 and the other methods described herein.

Furthermore, processor 310 may output one or more of approval indicator 330 and repayment terms 335. The outputting one or more of approval indicator 330 and repayment terms 335 may be similar to the corresponding functions described in relation to method 100 and the other methods described herein. For example, outputting one or more of approval indicator 330 and repayment terms 335 may comprise storing one or more of those entities in a memory, sending them to an output terminal, communicating them to another component or to another system, or the like. Moreover, in some examples outputting the approval indicator 330 or repayment terms 335 may comprise printing one or more of them.

As discussed above, in some examples assessment engine 205 may comprise an AI-enabled module. Processor 310 may use the AI-enabled module to one of more of obtain assessment 325, generate approval indictor 330, obtain repayment terms 335, and the like. In some examples, the AI-enabled modules may be part of or implemented by processor 310. Furthermore, in some examples, the AI-enabled module may be a component of assessment engine 205 separate from processor 310. In addition, in some examples, the AI-enabled module may comprise a trained machine learning model. Moreover, in some examples, the trained machine learning model may comprise a trained neural network.

In some examples, processor 310 may generate assessment 325 based on the parameters associated with loan request 320. Furthermore, in some examples, such parameters may comprise the amount of the loan, a selection of transactions associated with the payment account, a credit report, a credit score, and the like.

In addition, in some examples, assessment 325 may comprise a creditworthiness indicator, which may be generated by processor 310. In some such examples, processor 310 may generate approval indicator 330 based on the credit worthiness indicator. Moreover, in some examples, processor 310 may generate repayment terms 335 based on the creditworthiness indicator.

Furthermore, in some examples, processor 310 may transfer loan funds of the given amount to a destination account associated with a requester associated with the payment account. Processor 310 may affect this transfer directly or indirectly. In some examples, processor 310 may control or instruct another gateway or intermediary to affect the transfer of the loan funds. Moreover, in some examples, transfer of funds may comprise a credit of the given amount being added to the destination account. In some examples, the destination account may be the same as the payment account.

Moreover, in some examples, processor 310 may collect funds from a source account based on the repayment terms. The source account may be associated with a requester associated with the payment account. Processor 310 may collect the funds directly or indirectly. In some examples, processor 310 may control or instruct another gateway or intermediary to affect the collection of the funds. Moreover, in some examples, transfer of funds may comprise applying a debit to the source account. In some examples, the source account may be the same as the payment account.

In addition, in some examples, processor 310 may also send loan request 320 to a bid gateway, and receive from the bid gateway one or more bids to lend the given amount. Processor 310 may also generate approval indicator 330 based on the one or more bids. In some such examples, processor 310 may generate assessment 325 based on the parameters and send this assessment to the bid gateway. Moreover, in some examples, processor 310 may generate repayment terms 335 based on assessment 325, and send the repayment terms to the bid gateway.

Furthermore, in some examples, processor 310 may send the parameters to the bid gateway. One or more of the bids may comprise a bidder-generated assessment. Processor 310 may receive this bidder-generated assessment as assessment 325. Moreover, in some examples, processor 310 may send one or more of the parameters and assessment 325 to the bid gateway. One or more of the bids may comprise bidder-generated repayment terms. Processor 310 may receive the bidder-generated repayment terms as repayment terms 335.

Moreover, in some examples, processor 310 may select a successful bid from among the one or more bids received from the bid gateway. Processor 310 may then generate approval indicator 330 based on the successful bid. Processor 310 may also obtain the repayment terms associated with this successful bid as repayment terms 335.

In some examples, processor 310 may receive account credentials for accessing the payment account. Furthermore, in some examples, the payment account may comprise a credit card, debit card, electronic payment account, a cryptocurrency account, and the like.

As described above, the functions and features described in relation to processor 310 and assessment engine 205 may be similar to the corresponding functions and features described in relation to method 100 and the other methods described herein.

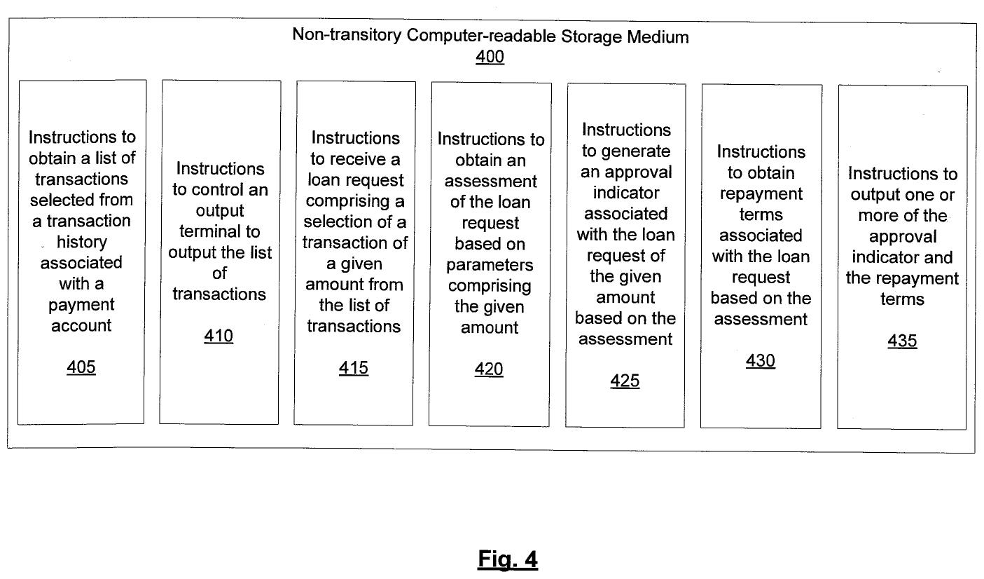

Turning now to FIG. 4, an example non-transitory computer-readable storage medium (CRSM) 400 is shown, which CRSM 400 comprises instructions executable by a processor. The CRSM may comprise any electronic, magnetic, optical, or other physical storage device that stores executable instructions. The functions and features of the CRSM 400 may be similar to the functions and features described in relation to the methods, systems, and assessment engines described herein.

The instructions may comprise instructions 405 to obtain a list of transactions selected from a transaction history associated with a payment account, and instructions 410 to control an output terminal to output the list of transactions. The instructions may also comprise instructions 415 to receive a loan request comprising a selection of a transaction of a given amount from the list of transactions, and instructions 420 to obtain an assessment of the loan request based on parameters comprising the given amount.

In addition, the instructions may comprise instructions 425 to generate an approval indicator associated with the loan request of the given amount based on the assessment. Moreover, the instructions may comprise instructions 430 to obtain repayment terms associated with the loan request based on the assessment, and instructions 435 to output one or more of the approval indicator and the repayment terms.

It is contemplated that in some examples, CRSM 400 may also comprise instructions to cause a processor to carry out the methods or perform the functions or feature described in relation to method 100, system 200, assessment engine 205, and the other methods, systems, and assessment engines described herein.

The methods described herein may be performed using the systems described herein. In this context, “system” includes the systems and devices described herein, including the assessment engines described herein, and the like. In addition, it is contemplated that the methods described herein may be performed using systems different than the systems described herein. Moreover, the systems described herein may perform the methods described herein and may perform or execute the instructions stored in the CRSMs described herein. It is also contemplated that the systems described herein may perform functions or execute instructions other than those described in relation to the methods and CRSMs described herein.

Furthermore, the CRSMs described herein may store instructions corresponding to the methods described herein, and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

Throughout this specification and the appended claims, infinitive verb forms are often used. Examples include, without limitation: “to output,” “to obtain,” “to generate,” and the like. Unless the specific context requires otherwise, such infinitive verb forms are used in an open, inclusive sense, that is as “to, at least, output,” to, at least, obtain,” “to, at least, generate,” and so on.

The above description of illustrated example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method comprising:
obtaining at an assessment engine a list of transactions selected from a transaction history associated with a payment account;
outputting at an output terminal the list of transactions;
receiving at the assessment engine a loan request comprising a selection of a transaction of a given amount from the list of transactions;
obtaining at the assessment engine an assessment of the loan request based on parameters comprising the given amount;
generating at the assessment engine an approval indicator associated with the loan request of the given amount based on the assessment;
obtaining at the assessment engine repayment terms associated with the loan request based on the assessment; and
outputting one or more of the approval indicator and the repayment terms.

2. The method of claim 1, wherein:
the assessment engine comprises an Artificial Intelligence (AI)-enabled module to be used to perform one of more of the obtaining the assessment, the generating the approval indictor, and the obtaining the repayment terms.

3. The method of claim 2, wherein:
the AI-enabled module comprises a trained machine learning model.

4. The method of claim 3, wherein:
the trained machine learning model comprises a trained neural network.

5. The method of any one of claims 1 to 4, wherein the obtaining the assessment comprises generating the assessment at the assessment engine based on the parameters.

6. The method of any of one of claims 1 to 5, wherein the parameters further comprise one or more of: a selection of transactions associated with the payment account, a credit report, and a credit score.

7. The method of any of claims 1 to 6, wherein:
the obtaining the assessment comprises generating at the assessment engine the assessment comprising a creditworthiness indicator; and
one or more of:
the generating the approval indicator comprises generating the approval indicator based on the creditworthiness indicator; and
the obtaining the repayment terms comprises generating the repayment terms at the assessment engine based on the creditworthiness indicator.

8. The method of any one of claims 1 to 7, further comprising:
transferring loan funds of the given amount to a destination account associated with a requester associated with the payment account.

9. The method of claim 8, wherein the destination account is the payment account.

10. The method of any one of claims 1 to 9, further comprising:
collecting funds from a source account based on the repayment terms, the source account associated with a requester associated with the payment account.

11. The method of claim 10, wherein the source account is the payment account.

12. The method of any one of claims 1 to 4, further comprising:
sending from the assessment engine to a bid gateway the loan request;
receiving at the assessment engine from the bid gateway one or more bids to lend the given amount; and
generating the approval indicator based on the one or more bids.

13. The method of claim 12, wherein:
the obtaining the assessment comprises generating the assessment at the assessment engine based on the parameters; and
the method further comprises:
sending from the assessment engine to the bid gateway the assessment.

14. The method of claim 13, wherein:
the obtaining the repayment terms comprises generating the repayment terms at the assessment engine based on the assessment; and
the method further comprises:
sending from the assessment engine to the bid gateway the repayment terms.

15. The method of claim 12, further comprising:
sending the parameters from the assessment engine to the bid gateway; and
wherein:
the one or more bids each comprise a bidder-generated assessment; and
the obtaining the assessment at the assessment engine comprises receiving at the assessment engine the bidder-generated assessment.

16. The method of any one of claims 12, further comprising:
sending one or more of the parameters and the assessment from the assessment engine to the bid gateway; and
wherein:
the one or more bids each comprise bidder-generated repayment terms; and
the obtaining the repayment terms at the assessment engine comprises receiving at the assessment engine the bidder-generated repayment terms.

17. The method of any one of claims 12 to 16, further comprising:
selecting at the assessment engine a successful bid from among the one or more bids; and
wherein, one or more of:
the generating the approval indicator comprises generating at the assessment engine the approval indicator based on the successful bid; and
the obtaining the repayment terms comprises obtaining at the assessment engine repayment terms associated with the successful bid.

18. The method of any one of claims 1 to 17, further comprising: receiving at the assessment engine account credentials for accessing the payment account.

19. The method of any one of claims 1 to 18, wherein the payment account comprises one of a credit card, debit card, electronic payment account, and cryptocurrency account.

20. An assessment engine comprising:
a memory to store a list of transactions selected from a transaction history associated with a payment account; and
a processor in communication with the memory, the processor to:
obtain the list of transactions;
control an output terminal to output the list of transactions;
receive a loan request comprising a selection of a transaction of a given amount from the list of transactions;
obtain an assessment of the loan request based on parameters comprising the given amount;
generate an approval indicator associated with the loan request of the given amount based on the assessment;
obtain repayment terms associated with the loan request based on the assessment; and
output one or more of the approval indicator and the repayment terms.

21. The assessment engine of claim 20, wherein:
the assessment engine comprises an Artificial Intelligence (AI)-enabled module; and
the processor is to use the AI-enabled module to one of more of obtain the assessment, generate the approval indictor, and obtain the repayment terms.

22. The assessment engine of claim 21, wherein:
the AI-enabled module comprises a trained machine learning model.

23. The assessment engine of claim 22, wherein:
the trained machine learning model comprises a trained neural network.

24. The assessment engine of any one of claims 20 to 23, wherein to obtain the assessment the processor is to generate the assessment based on the parameters.

25. The assessment engine of any of one of claims 20 to 24, wherein the parameters further comprise one or more of: a selection of transactions associated with the payment account, a credit report, and a credit score.

26. The assessment engine of any of claims 20 to 25, wherein:
to obtain the assessment the processor is to generate the assessment comprising a creditworthiness indicator; and
one or more of:
to generate the approval indicator the processor is to generate the approval indicator based on the creditworthiness indicator; and
to obtain the repayment terms the processor is to generate the repayment terms based on the creditworthiness indicator.

27. The assessment engine of any one of claims 20 to 26, wherein the processor is further to:
transfer loan funds of the given amount to a destination account associated with a requester associated with the payment account.

28. The assessment engine of claim 27, wherein the destination account is the payment account.

29. The assessment engine of any one of claims 20 to 28, wherein the processor is further to:
collect funds from a source account based on the repayment terms, the source account associated with a requester associated with the payment account.

30. The assessment engine of claim 29, wherein the source account is the payment account.

31. The assessment engine of any one of claims 20 to 23, wherein the processor is further to:
send to a bid gateway the loan request;
receive from the bid gateway one or more bids to lend the given amount; and
generate the approval indicator based on the one or more bids.

32. The assessment engine of claim 31, wherein:
to obtain the assessment the processor is to generate the assessment based on the parameters; and
send to the bid gateway the assessment.

33. The assessment engine of claim 32, wherein:
to obtain the repayment terms the processor is to generate the repayment terms based on the assessment; and
the processor is further to:
send to the bid gateway the repayment terms.

34. The assessment engine of claim 31, wherein the processor is further to:
send the parameters to the bid gateway; and
wherein:
the one or more bids each comprise a bidder-generated assessment; and
to obtain the assessment the processor is to receive the bidder-generated assessment.

35. The assessment engine of any one of claims 31, wherein the processor is further to:
send one or more of the parameters and the assessment to the bid gateway; and
wherein:
the one or more bids each comprise bidder-generated repayment terms; and
to obtain the repayment terms the processor is to receive the bidder-generated repayment terms.

36. The assessment engine of any one of claims 31 to 35, wherein the processor is further to:
select a successful bid from among the one or more bids; and
wherein, one or more of:
to generate the approval indicator the processor is to generate the approval indicator based on the successful bid; and
to obtain the repayment terms the processor is to obtain repayment terms associated with the successful bid.

37. The assessment engine of any one of claims 20 to 36, wherein the processor is further to: receive account credentials for accessing the payment account.

38. The assessment engine of any one of claims 20 to 37, wherein the payment account comprises one of a credit card, debit card, electronic payment account, and cryptocurrency account.

39. A non-transitory computer-readable storage medium comprising instructions executable by a processor, the instructions to cause the processor to carry out the method of any one of claims 1 to 19.
